(19) United States
(12) Patent Application Publication
(10) Pub. No.: US 2009/0240580 A1
(43) Pub. Date: Sep. 24, 2009

(54) Method and Apparatus for Automatically Targeting and Modifying Internet Advertisements

(76) Inventors: Michael Schwarz, Berkeley, CA (US); Alexander Berg, El Cerrito, CA (US)

Correspondence Address: STATTLER - SUH PC, 60 SOUTH MARKET STREET, SUITE 480, SAN JOSE, CA, 95113, US

(21) Appl. No.: 12/054,308

(22) Filed: Mar. 24, 2008

(51) Int. Cl. G06Q 30/00

(52) U.S. Cl. 705/14

(57) ABSTRACT

A method and apparatus are provided for automatically targeting and modifying an Internet ad. In one example, the method includes receiving a page and an ad to be placed on the page, rendering the page into a graphical format, computing descriptive features about the graphical format, mapping the descriptive features to parameters for rendering the ad, and rendering the ad based on the parameters.

### FIELD OF THE INVENTION

The present invention relates to serving appropriate ads to a webpage. More particularly, the present invention relates to serving appropriate ads by automatically targeting and modifying ads for a webpage.

### BACKGROUND OF THE INVENTION

An advertiser, such as Ford® or McDonald's®, generally contracts an advertising agency for ads in different media for its products. Such media may include banner display ads, textual ads (which may appear as hyperlinks), streaming ads (which stream across a digital display like stock quotes), mobile phone ads, print media ads, for example, in newspapers, magazines and posters. It is quite possible that the advertiser may engage one or more advertising agencies that specialize in creating ads for one or more of the above media.

Unfortunately, the advertising agency in turn must generate ads specific to specific medium. For each medium, the ads are specifically generated. Such custom tailored generation implies that the person concerned with creating ads must generate a separate ad for each medium. The number of different ads is about equal to the number of different media. Further, once an advertising firm creates an ad, the ad is limited and very specific for its very specific media. For example, ads created for a browser on a desktop cannot be seen correctly over a mobile phone. Similarly, an ad created for, say, a daily newspaper cannot be printed in a glossy magazine. Often, the limitations are due to the fact that different media have different ways of exposing a product's ad. Another problem arises when the advertiser wishes to add a new type of medium to the existing types of mediums. The ad agency must figure out a way to display the same product, for which there already are a number of ads, on the newly invented medium. The ad agency must create an entirely new ad for that same product in order to display the product's ad on that new medium. This problem is compounded when the ad agency services multiple companies in a similar manner.

Another important problem is that the look and feel of graphical ads is not matched to the look and feel of a page. For example, an advertiser who bought a graphical ad on Yahoo!® front page cannot adjust the color of the ad depending on the colors and shapes of images on the Yahoo!® front page.

### SUMMARY OF THE INVENTION

What is needed is an improved method having features for addressing the problems mentioned above and new features functionality not yet discussed. Broadly speaking, the present invention fills these needs by providing a method and apparatus for automatically targeting and modifying an Internet ad. It should be appreciated that the present invention can be implemented in numerous ways, including as a method, a process, an apparatus, a system or a device. Inventive embodiments of the present invention are summarized below.

In one embodiment, a method is provided for automatically targeting and modifying an ad, the method comprises receiving a page and an ad to be placed on the page, rendering the page into a graphical format, computing descriptive features about the graphical format, mapping the descriptive features to parameters for rendering the ad, and rendering the ad based on the parameters.

In another embodiment, an apparatus is provided for automatically targeting and modifying an ad, the apparatus comprises a receiver device configured to receive a page and an ad to be placed on the page, a graphics device configured to render the page into a graphical format, a features device configured to compute descriptive features about the graphical format, a parameters device configured to map the descriptive features to parameters for rendering the ad, and an ad render device configured to render the ad based on the parameters.

In still another embodiment, a computer readable medium carrying one or more instructions for automatically targeting and modifying an ad is provided. The one or more instructions, when executed by one or more processors, cause the one or more processors to perform the steps of receiving a page and an ad to be placed on the page, rendering the page into a graphical format, computing descriptive features about the graphical format, mapping the descriptive features to parameters for rendering the ad, and rendering the ad based on the parameters.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a system for automatically targeting and modifying ads, in accordance with an embodiment of the present invention; and

FIG. 2 is a flowchart of method of automatically targeting and modifying ads based on visual characteristics of the page where the ad server is to serve the ad, in accordance with an embodiment of the present invention.

### DETAILED DESCRIPTION OF THE INVENTION

An invention for a method and apparatus for automatically targeting and modifying an Internet ad is disclosed. Numerous specific details are set forth in order to provide a thorough understanding of the present invention. It will be understood, however, to one skilled in the art, that the present invention may be practiced with other specific details.

### General Overview

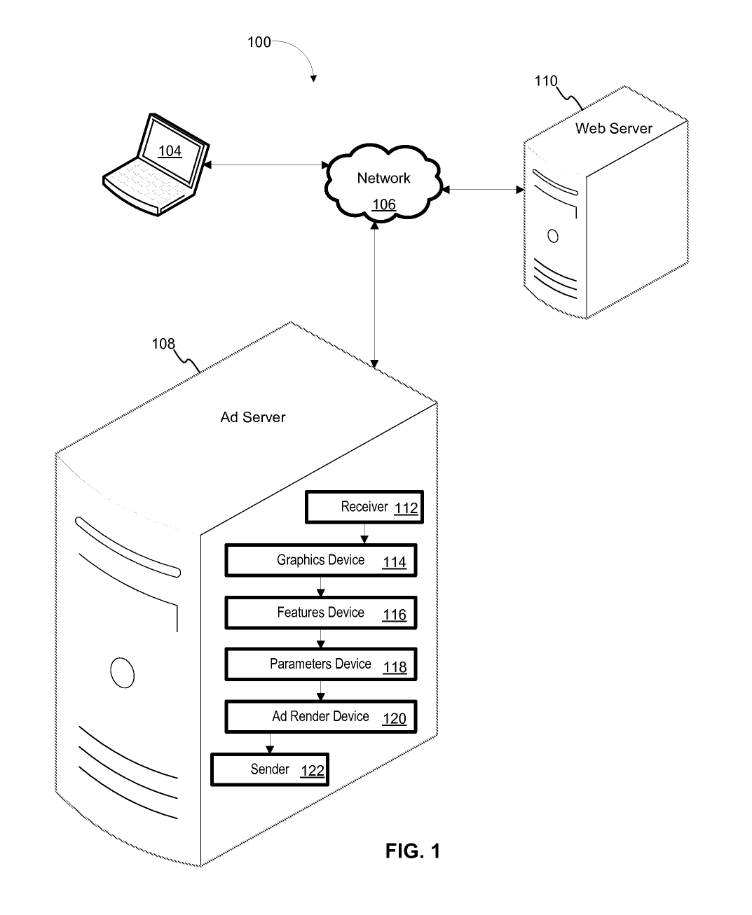

FIG. 1 is a block diagram of a system 100 for automatically targeting and modifying ads, in accordance with an embodiment of the present invention. The system 100 allows advertisers to tailor automatically the look and/or the context of the ad based on the graphical and other attributes of the page where the ad server 108 will serve the ad. A user computer 104 is coupled to a network 106, which is coupled to an ad server 108 and to a web server 114. The network 106 is any combination of networks, including but not limited to the Internet, a local area network, a wide area network, a wireless network and a cellular network. The web server 110, along with the ad server 108, serves pages to the user computer 104. The user computer 104 is any type of user computing device, such as a desktop computer, a laptop computer, a personal digital assistant, a mobile device or a cellular phone, among other devices.

The ad server 108 extracts graphical features of a page. For example, the ad server 108 may determine if the page is in black and white or if the page is in color; the ad server 108 may determine the percentage of the page that has images; or the ad server 108 may determine the presence of facial images on the page, among other things. The ad server 108 then uses the features that the ad server 108 extracts from the page to choose the ad or to render ads. For example, the ad server 108 may choose to serve black and white ads onto pages that have a lot of color; ad server 108 may choose to serve and color ads on pages that are black and white. This strategy would be effective if, for example, users tend to react more strongly to the ad when it contrasts to the page.

An important part of the present invention is that the ad server 108 may take into account information about graphical aspects of the page when choosing or designing an ad for a page. The graphical information about the page where the ad is to appear can be useful for designing the look of the ad. The ad server 108 may also combine graphical information with other types of information about the page in order to choose appropriate text for an ad. Alternatively, the ad server 108 may be configured to use the same technology in an off line world (e.g., newspaper ads, etc.), even though such an application is less interesting.

A device of the present invention is hardware, software or a combination thereof. Each device is configured to carry out one or more steps for the method of automatically targeting and modifying Internet ads.

The ad server 108 receives a page displayed on the user computer 104 via the receiver device 112. The graphics device 114 renders the page into a graphical format. It is important to note that the page may have an HTML (hypertext markup language) format; however, the ad server 108 needs to render the page into a graphical format in order to analyze graphical attributes that are not immediately apparent from the HTML. The features device 116 computes descriptive features about the rendered page. The parameter device 118 maps the descriptive features to parameters for rendering an ad. The ad render device 120 provides the ad and the parameters or the actual parameters rendered with those parameters. The sender device 122 serves the ad to the user computer 104, which displays the ad.

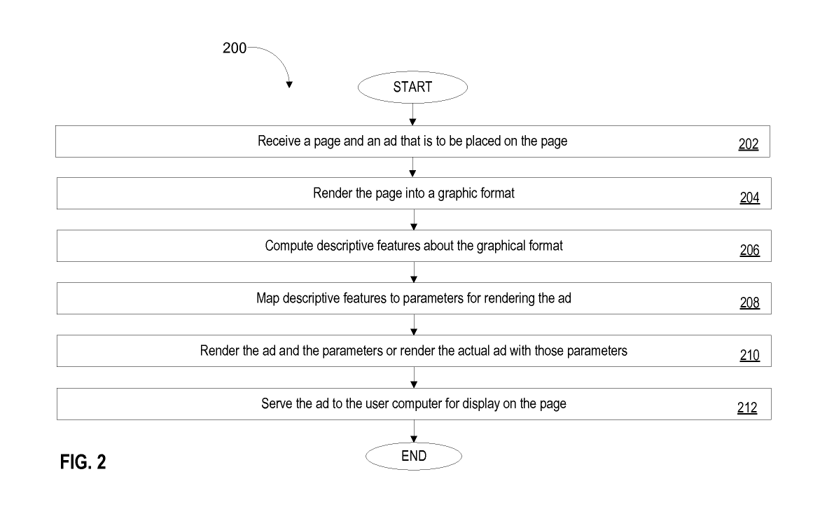

FIG. 2 is a flowchart of method 200 of automatically targeting and modifying ads based on visual characteristics of the page where the ad server is to serve the ad, in accordance with an embodiment of the present invention. The method 200 starts in step 202 where the system receives a page (W) and an ad (A) that is to be placed on the page (W). This step 202 may be carried out by the receiver device 112 of FIG. 1. So, the method 200 starts with a page (W), and an ad (A) to place on that page. Next, in step 204, the system renders the page the page (W) into a graphical format (I). This step 204 may be carried out by the graphics device 114 of FIG. 1. The method 200 then moves to step 206 where the system computes descriptive features (F) about the rendered page in its graphical format (I). This step 206 may be carried out by the features device 116 of FIG. 1 and may be expressed as

F=fᵢ(I), where i is an integer from 1 to n. Equation 1.

In other words, the system takes the graphical image of the page and figures out various visual features, for example, colors that appear. The system uses these visual features in later steps, described below, to render an ad that optimizes whatever metric the system is seeking to optimize. For example, the system may seek to optimize a metric that measures how many users respond to an ad, how many users click on an ad, how much money people spend on an ad, what type of people click on an ad, or how much revenue an ad generates, among other possible metrics. Accordingly, there are a number different metrics, which may not be outright stated here, that the system may seek to optimize. All of these different metrics are within the scope of the method.

The method then proceeds to step 208 where the system maps descriptive features (F) to parameters (p) for rendering the ad. This step 208 may be carried out by the parameters device 118 of FIG. 1 and may be expressed as

p=m(F). Equation 2.

A parameter (p) is something that influences the ad that the system is going to render. A feature (F) is a quantitative assessment of attributes on a page. For example, the parameter (p) may be an indication of whether the ad should be rendered in black and white or in color; the parameter (p) may indicate “yes” or “no”. In another example, the feature (F) indicates the average color of the page; the parameter (p) indicates what the color of the ad should be for that feature (F). In yet another example, the feature (F) indicates the page shows basically a white background; the mapping function may indicate a parameter (p) of a light background. In still another example, the feature (F) indicates the page shows a certain pattern of descriptive features; the mapping function may indicate a parameter (p) that indicates the ad should be of a particular pattern type.

Next, in step 210, the system renders the ad (A) and the parameters (p) or renders the actual ad (R) with those parameters. In other words, the system may render the ad (R) as the ad's HTML version including the parameters; alternatively, the system may render the ad (R) as the ad's actual graphical version. This step 210 may be carried out by the ad render device 120 of FIG. 1 and may be expressed as

R=render(A,p). Equation 3.

The step 210 is expressed as a function to highlight the fact that the parameter (p) can be more continuous, as opposed to more discrete. An example of a discrete parameter is one in which the parameter (p) is a binary indicator, 0 or 1, or “true” or “false”, or “yes” or “no”. However, the parameter (p) can be more continuous and, thus, more complex. For example, the parameter (p) may indicate what the average color of the ad should be; the feature (F) from Equation 2 may indicate how much image content is on the page or how much text content is on the page. In such a case, the parameter (p) indicates up to a substantial number of different options, for example, thousands of different options. With these more options, the system can render finely distinguished versions of the ad. The system may choose to render the ad based on a continuous measurement of, for example, the page's background color, the text content or the graphics pattern, among other things.

Next, in step 212, the system may serve the rendered ad (R) to the user computer for display on the page. This step 212 may be carried out by the sender device 122 of FIG. 1. Alternatively, the system may send the rendered ad back to original server, which may then serve the rendered ad to the user. For example, the system may send the rendered ad back to the web server 110 of FIG. 1, which may then serve the rendered ad to the user. The method 200 is then at an end.

### Examples of Implementation

In a first example, the system uses the presence of color in the page to determine if a color or monotone grayscale version of an ad is to be displayed. The system parameterizes the ad by a single binary parameter. A single binary parameter that is zero (0) indicates a grayscale monotone version of the ad is to be used. A single binary parameter that is one (1) indicates a color version of the ad is to be used. The system starts by rendering the page (W) into a graphical format (I).

Next, the system computes features according to Equation 1 above, where fᵢ(I) counts the number of pixels in the graphical format (I) with color saturation in the range rᵢ to rᵢ₊₁, where r₁=0, r₂=0.1, . . . , r₁₁=1.0. Here, color saturation is scaled to range from 0 to 1.

The mapping function m of Equation 2 maps p=0 indicating the gray version of the ad if fᵢ is zero for all i>1; otherwise, the mapping function m of Equation 2 maps p=1 indicating the color version of the ad. In other words, if the page has relatively low saturation, then the system may select a gray scale version of the ad; otherwise, if the page has relatively high saturation, then the system selects a color version of the ad.

If the result of the mapping function m is 0, use the gray version of the ad in the rendering of Equation 3 (R=A_{gray}). Otherwise, use the color version in the rendering of Equation 3 (R=A_{color}).

In a second example, a continuous version involves the system matching the saturation of the colors in an ad to the saturation of the colors on a page. Here, the ad is parameterized by a single parameter that indicates the desired saturation of the ad. There are at least two possibilities for implementing this parameterization. A first possibility is that the system provides a number of versions of the ad with different levels of saturation in advance; the system uses the ad version with the saturation closest to the parameters. A second possibility is that the system renders the ad by scaling down the saturation in one (highly saturated) version of the ad to the desired level. The system starts by rendering the page (W) into a graphical format (I).

Next, the system computes features according to Equation 1, where fᵢ(I) counts the number of pixels in the graphical format (I) with color saturation in the range rᵢ to rᵢ₊₁, where r₁=0, r₂=0.1, . . . , r₁₁=1.0. Here, color saturation is scaled to range from 0 to 1.

The mapping function m of Equation 2 maps F=(fᵢ) to the mean saturation, which is the sum ρᵢfᵢ*(rᵢ+rᵢ₊₁)/2. This summation value is the parameter (p) of Equation 2. The ad is then rendered to have saturation of approximately p. As described above in Equation 3, R=render(A,p).

This second example, in other words, involves the system using Equation 1 to measure the color saturation of all the pixels in the graphical image of the page. The system compartmentalizes into bins the measurements of the color saturation. Consider, for example, a system that has 100 levels of color saturation divided up into 10 different bins. Using Equation 2, the system then counts how much fell into each bin and uses the values in the bins to compute the mean saturation for the image.

In a third example, the system can make a choice between different images to include in the ad depending on the images present in the page. Here, the ad would be parameterized by a parameter specifying which image to include. The image would be selected based on how similar its features are to the features of other images on the page. In other words, the rendering device is deciding to render one of several different ad versions, for example, 10 different ad versions.

In a fourth example, the system may learn the mapping between features and parameters via a machine learning technique based on training models. For a particular ad or type of ad, the system provides models of pages and the desired set of parameters to render the ad on those pages to a machine learning algorithm. For example, the machine learning technique may involve learning which parameters cause the most click-throughs or the most user response, etc. The system then uses this algorithm to produce a mapping from features to parameters that the system may use in Equation 2.

The examples above may be carried out by an ad server of a company, such as Yahoo!®, that's serving ads on a number of different pages. Alternatively, if the advertiser has the ability to interact in real time with the ad server, the advertisers can be doing the computations of Equations 1-3 themselves. Accordingly, the computations do not necessarily have to done by a third party ad server. If an advertiser in the system knows what the page looks like and has its own means of making the computations, the system may inquire of the advertiser which ad the advertiser would like to serve; the advertiser, instead of the ad server, could then render and serve the ad. In a sense, the advertiser behaves as an ad server.

In an alternative embodiment, the system integrates non-visual features. Up to now, the system has been described with the features (F) of Equation 1 as being visual features. However, the embodiments of the present invention are not so limited. The features (F) of Equation 1 may be supplemented with non-visual features. For example, the system may supplement features (F) with other information, such as text on the page and page content (e.g., to guess the page topic), or user information, among other things, in order to calculate parameters for rendering an ad. In other words, the system may use non-visual features alone, or with other visual features, to select a visual appearance of the ad as described above with reference to the FIG. 1 and FIG. 2.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to receiving a page and an ad to be placed on the page, rendering the page into a graphical format, computing descriptive features about the graphical format, mapping the descriptive features to parameters for rendering the ad, and rendering the ad based on the parameters, according to processes of the present invention.

### Advantages

The ads that are better tailored to the look of the page may be more noticeable to the user, thus leading to higher value of the same space for the advertiser. Making the page appear more attractive can also improve the user experience. Also, It is important to note that a system with the ability to adjust appearance continuously is a particularly useful feature of the invention.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A computer-implemented method of automatically targeting and modifying an ad, the method comprising:
receiving, at a computer, a Web page and an ad for placement on the Web page;
rendering the Web page on the computer into a graphical format;
processing the graphical format of the Web page on the computer and rendering an ad on the computer by:
computing descriptive features about the graphical format, including color descriptive features of the graphical format;
mapping the color descriptive features to parameters for rendering the ad, wherein the parameters define color features of the ad; and
rendering the ad based on the parameters.

2. The method of claim 1, further comprising serving the ad to the user computer for display on the page.

3. The method of claim 1, further comprising taking the graphical image of the page and determining various visual features of the page.

4. The method of claim 1, wherein mapping the color descriptive features comprises generating a parameter indicating at least one of:
the page as being either gray scale or color;
the average color of the page as being a single value; and
the page as being that of a particular pattern.

5. The method of claim 1, wherein the rendering of the ad comprises at least one of:
rendering the ad as an hypertext markup language version of the ad including the parameters; and
rendering the ad as an actual graphical version of the ad,

6. The method of claim 1, wherein each of the parameters is one of:
a discrete function; or
more of a continuous than a discrete function, wherein a particular parameter indicates up to a substantial number of different options.

7. The method of claim 1, wherein computing the color descriptive features comprises using the presence of color in the page to determine if a color or monotone version of the ad is to be displayed.

8. The method of claim 1, wherein mapping the color descriptive features comprises matching saturation of colors in the ad to saturation of colors on the page.

9. The method of claim 8, further comprising:
providing in advance a number of versions of the ad with different levels of saturation; and
selecting an ad version with a saturation closest to the parameters.

10. The method of claim 8, further comprising rendering the ad by scaling down a saturation of the ad from a highly saturation level to a desired saturation level.

11. The method of claim 1, wherein mapping the color descriptive features comprises mapping the features to a mean saturation.

12. The method of claim 1, further comprises learning mapping between features of the page and parameters via a machine learning technique based on training models.

13. A computer for automatically targeting and modifying an ad, the computer comprising:
a receiver device configured to receive a Web page, over a network, and an ad for placement on the Web page;
a graphics device configured to render the Web page on the computer into a graphical format;
a features device configured to compute descriptive features about the graphical format, including color descriptive features of the graphical format;
a parameters device configured to map the descriptive features to parameters for rendering the ad, wherein the parameters define color features of the ad; and
an ad render device configured to render the ad based on the parameters.

14. The apparatus of claim 13, wherein the computer comprises an ad server.

15. The apparatus of claim 13, further comprising a sender device configured to serve the ad to the user computer for display on the Web page.

16. The apparatus of claim 13, wherein features device is further configured to take the graphical image of the page and determine various visual features of the page.

17. The apparatus of claim 13, wherein the parameters device is further configured to generate a parameter indicating at least one of:
the page as being either gray scale or color;
the page having an average color represented as a single value; and
the page as being that of a particular pattern.

18. The apparatus of claim 13, wherein the ad render device is further configured to at least one of:
render the ad as an hypertext markup language version of the ad including the parameters; and
render the ad as an actual graphical version of the ad,

19. The apparatus of claim 13, wherein each of the parameters is one of:
a discrete function; or
more of a continuous than a discrete function, wherein a particular parameter indicates up to a substantial number of different options.

20. The apparatus of claim 13, wherein the features device is further configured to use the presence of color in the page to determine if a color or monotone version of the ad is to be displayed.

21. The apparatus of claim 13, wherein the parameters device is further configured to match saturation of colors in the ad to saturation of colors on the page.

22. The apparatus claim 21, wherein the receiver device is further configured to provide in advance a number of versions of the ad with different levels of saturation, and wherein the ad render device is further configured to select an ad version with a saturation closest to the parameters.

23. The apparatus of claim 21, wherein the render device is further configured to render the ad by scaling down a saturation of the ad from a highly saturation level to a desired saturation level.

24. The apparatus of claim 13, wherein the parameters device is further configured to map the features to a mean saturation.

25. The apparatus of claim 13, wherein the apparatus is configured to learn mapping between features of the page and parameters via a machine learning technique based on training models.

26. A computer readable medium carrying one or more instructions for automatically targeting and modifying an ad, wherein the one or more instructions, when executed by one or more processors, cause the one or more processors to perform the steps of:
receiving a Web page and an ad for placement on the Web page;
rendering the Web page into a graphical format;
computing descriptive features about the graphical format, including color descriptive features of the graphical format;
mapping the color descriptive features to parameters for rendering the ad, wherein the parameters define color features of the ad; and
rendering the ad based on the parameters.
